(19) United States
(12) Patent Application Publication
(10) Pub. No.: US 2022/0196112 A1
(43) Pub. Date: Jun. 23, 2022

(54) TORSIONAL VIBRATION DAMPER

(71) Applicant: Toyota Jidosha Kabushiki Kaisha, Toyota-shi (JP)

(72) Inventors: Masayuki ISHIBASHI, Numazu-shi (JP); Yu SHIRAISHI, Susono-shi (JP); Hiroyuki AMANO, Susono-shi (JP)

(73) Assignee: Toyota Jidosha Kabushiki Kaisha, Toyota-shi (JP)

(21) Appl. No.: 17/455,475

(22) Filed: Nov. 18, 2021

(30) Foreign Application Priority Data
Dec. 18, 2020 (JP) 2020-210360

(51) Int. Cl. F16F 15/14

(52) U.S. Cl. CPC F16F 15/145; F16F 2222/08; F16F 2236/08; F16F 2230/0023; F16F 2232/02

(57) ABSTRACT

A torsional vibration damper having improved durability, whose vibration damping performance is ensured irrespective of machining error. The torsional vibration damper comprises: a rotary member rotated by torque; a retainer formed on the rotary member to protrude radially outwardly; a rolling member held in the retainer while being allowed to reciprocate in the retainer; and an inertia body arranged around the rotary member while being allowed to rotate relatively to the rotary member. An elastic member is arranged on any one of inner surfaces of the retainer to push a shaft of the rolling member toward the other one of the inner surfaces of the retainer.

The present disclosure claims the benefit of Japanese Patent Application No. 2020-210360 filed on Dec. 18, 2020 with the Japanese Patent Office, the disclosure of which is incorporated herein by reference in its entirety.

### BACKGROUND

### Field of the Disclosure

Embodiments of the present disclosure relate to the art of a torsional vibration damper that damps torsional vibrations resulting from a torque pulse by an oscillating motion of an inertia body, and more especially, to a torsional vibration damper configured to maintain a relative position between a rotary member and an inertia body connected through masses by a centrifugal force.

### Discussion of the Related Art

In the torsional vibration damper of this kind, a plurality of masses is held in a rotary member while being restricted to oscillate in a rotational direction, and each of the masses is centrifugally pushed onto a raceway surface of an inertia body during rotation of the rotary member. The inertia body is oscillated relatively to the rotary member by a pulsation of torque applied to the rotary member, and consequently the masses are pushed back by the raceway surfaces toward a rotational center of the rotary member. In this situation, each of the masses revolving around the rotational center is being subjected to the centrifugal force, and individually displaced radially outwardly. Consequently, each of the masses is pushed back to a radially outermost portion of the raceway surface, and a phase of the inertia body with respect to the rotary member is corrected to an initial phase by a torque derived from such centrifugal displacement of the mass. As a result, vibrations resulting from pulsation of the torque applied to the rotary member is damped by the torque correcting the phase of the inertia body.

In the torsional vibration damper of this kind, therefore, it is necessary to allow the masses to behave as desired so as to ensure the above-explained vibration damping torque. To this end, a torque fluctuation control device described in JP-A-2019-052714 is provided with a mechanism for reducing an inclination of a rolling member that reciprocates in response to torque pulse. Specifically, the torque fluctuation control device described in JP-A-2019-052714 comprises: a hub flange as a rotary member that is rotated by a torque; a centrifugal element that is displaced radially outwardly by a centrifugal force; a dent formed on an outer surface of the hub flange to hold the centrifugal element therein; an inertia ring that is arranged concentrically around the hub flange; and a cam mechanism that is arranged between a raceway surface as an inner surface of the inertia ring and the centrifugal element. The cam mechanism comprises a roller interposed between the centrifugal element and the raceway surface, and a recessed surface formed on a radially outer surface of the centrifugal element.

Accordingly, in the torque fluctuation control device taught by JP-A-2019-052714, the centrifugal element is centrifugally displaced radially outwardly toward the raceway surface during rotation of the hub flange so that the roller is clamped between the raceway surface and the centrifugal element. In this situation, the inertia ring is connected to the hub flange through the centrifugal element and the roller being pushed onto the raceway surface. Given that the torque rotating the hub flange is smooth and hence the hub flange and the inertia ring are rotated in phase with each other, the roller is pushed onto a radially outermost portion (i.e., a neutral position) of the raceway surface that is farthest from a rotational center of the hub flange. That is, a normal line at a contact point between the roller and the raceway surface coincides with a direction of action of the centrifugal force. In this situation, therefore, the torque derived from the centrifugal force does not act between the hub flange and the inertia ring. When the torque rotating the hub flange is pulsated thereby shifting a rotational phase of the inertia ring with respect to the hub flange, the roller is oscillated from the neutral position and pushed back radially inwardly by the raceway surface. In this situation, the normal line at the contact point between the roller and the raceway surface deviates from the direction of action of the centrifugal force, and the roller is returned to the neutral position by the centrifugal force. As a result, the torque derived from the centrifugal force acts between the hub flange and the inertia ring in a direction to damp vibrations resulting from pulsation of the torque rotating the hub flange.

In the torsional vibration damper of this kind, a connecting member such as the above-mentioned centrifugal element interposed between the rotary member and the inertia body reciprocates in the radial direction within a guide member. In order to allow the connecting member to reciprocate smoothly along the guide member, it is preferable to maintain a predetermined clearance between the connecting member and the guide member. However, if the connecting member is displaced undesirably within the above-mentioned clearance and consequently a contact point between the connecting member and the guide member is changed, a torque would act in an undesirable direction due to such displacement of the above-mentioned contact point thereby reducing vibration damping performance of the torsional vibration damper. In order to avoid such disadvantage, according to the teachings of JP-A-2019-052714, the clearance between the centrifugal element and the hub flange is eliminated by elastic members arranged on both sides of the centrifugal element.

In the torque fluctuation control device taught by JP-A-2019-052714, therefore, the centrifugal element is supported equally by the elastic members without tilting. That is, the centrifugal element is always positioned at a center of the dent of the hub flange. If the raceway surface is shaped precisely, the centrifugal element thus supported without tilting would be contacted to the center of the raceway surface (i.e., maintained at the neutral position) as long as the torque rotating the hub flange is not pulsated. However, the raceway surface as an arcuate or curved surface is formed on a plurality of sites of the inertia body around the rotational center, and hence profiles of the raceway surfaces may be slightly different from one another due to inevitable machining error. For example, in a torsional vibration damper in which a plurality of pairs of raceway surfaces is formed on both sides of the inertia body in a thickness direction, the raceway surfaces of one side of the inertia body are machined by fixing a processing site to a reference point, and then, the raceway surfaces of the other side of the inertia body are machined by fixing a processing site to the reference point. In the torsional vibration damper of this kind, therefore, the processing sites of one surface and the other surface would be fixed to slightly different points thereby inducing a machining error. If the raceway surfaces of the torque fluctuation control device taught by JP-A-2019-052714 are machined by the above-explained procedures, the raceway surfaces may not be machined accurately to have a desired cam profile. Consequently, the centrifugal element being positioned at the center of the dent by the elastic members may not achieve a desired cam motion, and the vibration damping performance of the torque fluctuation control device taught by JP-A-2019-052714 would be reduced.

### SUMMARY

Aspects of embodiments of the present disclosure have been conceived noting the foregoing technical problems, and it is therefore an object of the present disclosure to provide a torsional vibration damper having improved durability, whose vibration damping performance is ensured irrespective of machining error.

According to the exemplary embodiment of the present disclosure, there is provides a torsional vibration damper comprising: a rotary member that is rotated by a torque applied thereto; a retainer that is formed on the rotary member to extend radially outwardly; a rolling member that is held in the retainer while being allowed to reciprocate in a radial direction of the rotary member; and an inertia body that is arranged coaxially with the rotary member while being allowed to oscillate relatively to the rotary member. Specifically, the rolling member comprises a shaft that is inserted into the retainer to be guided in the radial direction by the retainer, and a pair of masses formed on end portions of the shaft to be rotated integrally with the shaft. The inertia body comprises a raceway surface to which the mass of the rolling member is centrifugally contacted, and the retainer comprises a pair of inner surfaces opposed to each other in a circumferential direction across the shaft of the rolling member. In the torsional vibration damper, an elastic member is arranged on any one of the inner surfaces of the retainer to push the shaft of the rolling member toward the other one of the inner surfaces of the retainer.

In a non-limiting embodiment, the shaft may comprise a shaft portion formed integrally with the pair of masses and a bearing fitted onto the shaft portion, and the elastic member may push an outer circumferential surface of the shaft portion.

In a non-limiting embodiment, a plurality of the retainers may be formed on the rotary member at regular intervals in the circumferential direction, and the elastic members may be arranged in the retainers in such a manner as to push the shafts of the rolling members in the same direction.

In a non-limiting embodiment, the elastic member arranged in a predetermined retainer of the plurality of the retainers may push the shaft of the rolling member in an opposite direction to a direction to push the shaft of the rolling member by the elastic member arranged in another predetermined retainer of the plurality of the retainers.

In a non-limiting embodiment, an even number of the retainers may be formed on the rotary member at regular intervals in the circumferential direction. In this case, the elastic members arranged in a predetermined pair of the retainers opposed to each other in the radial direction may push the shafts of the rolling members in the same direction. On the other hand, the elastic members arranged in another predetermined pair of the retainers opposed to each other in the radial direction may push the shafts of the rolling members in the same direction, which is opposite to the direction to push the shafts of the rolling members by the elastic members arranged in the predetermined pair of the retainers.

In a non-limiting embodiment, the elastic members arranged in a predetermined pair of the retainers opposed to each other in the radial direction may push the shafts of the rolling members in opposite directions.

In a non-limiting embodiment, the raceway surface may be a curved surface depressed radially outwardly that is formed on the inertia body in radially outer side of the mass held in the retainer, and a curvature radius of the curved surface may be shorter than a radius of the inertia body between a rotational center of the inertia body and the curved surface.

In the torsional vibration damper according to the exemplary embodiment of the present disclosure, during rotation of the rotary member, the rolling members held in the retainers of the rotary member are displaced radially outwardly along the retainers by the centrifugal force. Consequently, each of the rolling member comes into contact to the raceway surface of the inertia body. In this situation, a reaction force of the raceway surface against the centrifugal force is applied to the rolling member at a contact point between the rolling member and the raceway surface. Accordingly, given that a normal line passing through the above-mentioned contact point and a rotational center of the rotary member coincides with a direction of action of the centrifugal force at the above-mentioned contact point, a torque will not act between the rolling member (or the rotary member) and the inertia body. When the inertial body is rotated relatively to the rotary member by an inertia force of the inertia body derived from a pulsation of torque rotating the rotary member, in other words, when a phase of the inertia body is shifted with respect to the rotary member, the rolling member rolls on the raceway surface. Consequently, the direction of action of the centrifugal force of the rolling member is shifted from the normal line at the contact point between the rolling member and the raceway surface, and a torque derived from the centrifugal force acts between the rolling member (or the rotary member) and the inertia body. As a result, the phase of the inertia body with respect to the rotary member is corrected thereby damping vibrations resulting from the pulsation of the torque rotating the rotary member.

In the torsional vibration damper according to the exemplary embodiment of the present disclosure, a relative position of the rolling member with respect to the raceway surface is governed by the centrifugal force of the rolling member and the reaction force of the raceway surface applied to the rolling member. Accordingly, the rolling member is subjected to a reaction force derived from a machining error of the raceway surface. However, the rolling member being pushed by the elastic member in the retainer is allowed to move in the circumferential direction in the retainer within a range of expansion and contraction of the elastic member. Therefore, the rolling member is moved to a point at which the reaction force and the centrifugal force balance each other. In other words, the machining error of the raceway surface is absorbed or eliminated by a movement of the rolling member. That is, since a circumferential movement of the rolling member is not restricted completely in the retainer, the rolling member will not be fixed on the raceway surface to an undesirable contact point at which the rolling member is positioned due to the machining error of the raceway surface. Therefore, the rolling member is allowed to move to a neutral point in the raceway surface so that the undesirable displacement of the rolling member due to machining error of the raceway surface is corrected. For example, given that the torque rotating the rotary member is smooth, a direction of action of the centrifugal force of the rolling member (i.e., a pushing force of the rolling member applied to the raceway surface) coincides with a normal line at the contact point between the rolling member and the raceway surface. In this situation, when the inertia body is rotated relatively to the rotary member by a pulsation of the torque rotating the rotary member, the rolling member is pushed radially inwardly by the raceway surface. Consequently, the rolling member is displaced from the neutral position of the raceway surface, and a torque to rotate the inertia body in a direction to return the rolling member to the neutral position of the raceway surface is established in accordance with the centrifugal force of the rolling member. Such torque rotating the inertia body serves as a vibration damping force. According to the exemplary embodiment of the present disclosure, therefore, vibration damping performance of the torsional vibration damper can be ensured. In addition, an impactive force of the rolling member applied to one of the inner surfaces of the retainer may be absorbed by the elastic member. Further, since the rolling member is pushed toward the other one of the inner surfaces of the retainer by the elastic member, a clearance between the rolling member and the other one of the inner surfaces is reduced. For this reason, an impactive force of the rolling member applied to the other one of the inner surfaces is not so strong, and hence the damage of the retainer may be limited.

As described, the elastic members may be arranged in opposite directions in the retainers thereby cancelling elastic forces of the elastic members each other. In this case, a force of the inertia body pushing the shaft of the rolling member onto the inner surface of the retainer can be reduced. Consequently, the impactive force of the rolling member applied to the inner surface of the retainer can be reduced to limit damage of the retainer.

### BRIEF DESCRIPTION OF THE DRAWINGS

Features, aspects, and advantages of exemplary embodiments of the present disclosure will become better understood with reference to the following description and accompanying drawings, which should not limit the disclosure in any way.

FIG. 1 is an exploded perspective view showing constitutional elements of the torsional vibration damper according to exemplary embodiment of the present disclosure;

FIG. 2 is a front view showing a first example of a structure of a hub plate;

FIG. 3 is a partial enlarged view showing an example in which a raceway surface is formed accurately;

FIG. 4 is a partial enlarged view showing an example in which the raceway surface is formed with a machining error;

FIG. 5 is a partial enlarged view showing a situation where the rolling mass comes into contact to a neutral point of a raceway surface formed with a machining error;

FIG. 6 is a front view showing a second example of a structure of a hub plate;

FIG. 7 is a front view showing a third example of a structure of a hub plate; and

FIG. 8 is a front view showing a fourth example of a structure of a hub plate.

### DETAILED DESCRIPTION OF THE PREFERRED EMBODIMENT(S)

Embodiments of the present disclosure will now be explained with reference to the accompanying drawings. Note that the embodiments shown below are merely examples of the present disclosure which should not limit a scope of the present disclosure.

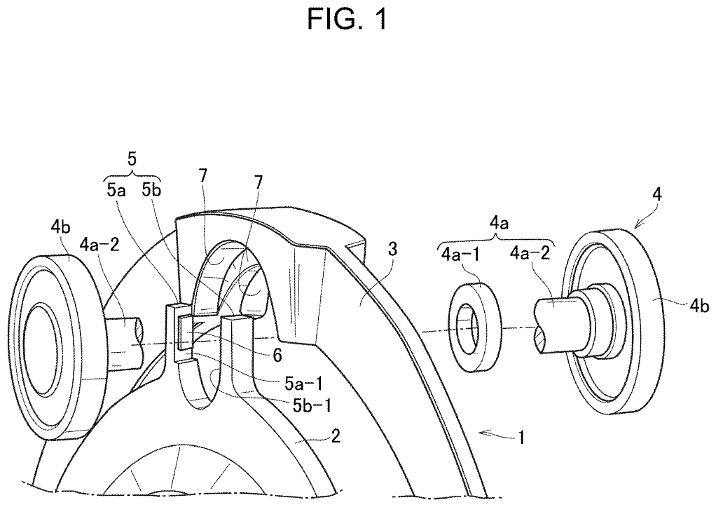

Here will be explained a fundamental structure of the torsional vibration damper according to the exemplary embodiment of the present disclosure with reference to FIG. 1. A torsional vibration damper 1 comprises a hub plate 2 as a rotary member that is rotated by a torque applied thereto, and an inertia body 3 that is arranged concentrically around the hub plate 2. The torque rotating the hub plate 2 is pulsated inevitably e.g., by a combustion in an internal combustion engine. Specifically, the inertia body 3 is connected to the hub plate 2 through a plurality of rolling members such as centrifugal weights 4 interposed therebetween so that the inertia body 3 is oscillated relatively to the hub plate 2 in response to the pulsation of the torque applied to the hub plate 2. That is, vibrations resulting from pulsation of the torque applied to the hub plate 2 is damped by an inertial force of the inertial mass being oscillated by the pulsation of the torque.

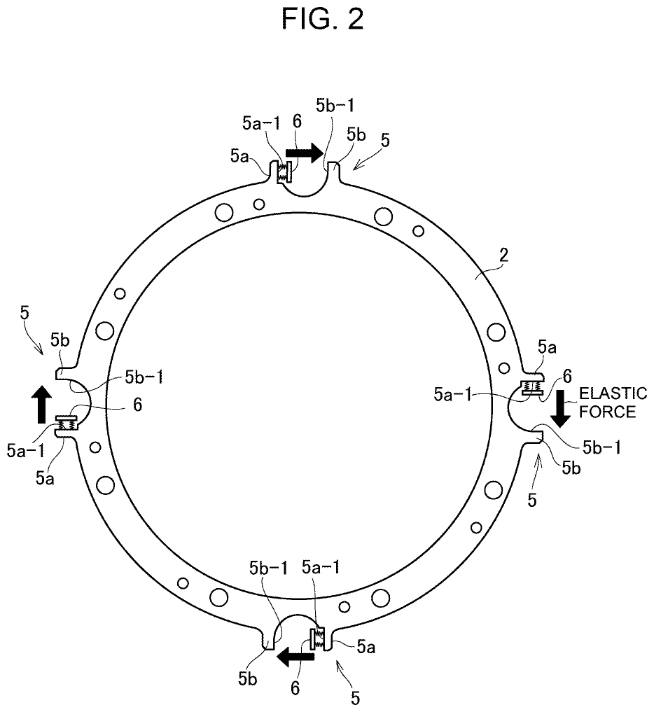

Specifically, the hub plate 2 is a disc member that is mounted on e.g., an output shaft of the engine (neither of which are shown). FIG. 2 shows a first example of a structure of the hub plate 2. As illustrated in FIG. 2, a plurality of retainers 5 are formed on an outer circumference of the hub plate 2 at regular intervals in the circumferential direction, and the centrifugal weight 4 is held in each of the retainers 5. In the retainer 5, the centrifugal weight 4 is allowed to reciprocate in the radial direction but restricted to oscillate in the circumferential direction. Specifically, each of the retainers 5 comprises: a pair of column-shaped stoppers 5a and 5b extending radially outwardly from the outer circumference of the hub plate 2 and in parallel to each other; and a U-shaped bottom as a dent formed between the stoppers 5a and 5b.

As illustrated in FIGS. 1 and 2, an inner surface 5a-1 of one of the stoppers 5a is slightly recessed in the circumferential direction, and an elastic member 6 is arranged on the inner surface 5a-1 to elastically push the centrifugal weight 4 toward an inner surface 5b-1 of the other one of the stoppers 5b. In other words, the centrifugal weight 4 held in the retainer 5 is pushed toward the inner surface 5b-1 by an elastic force of the elastic member 6 in the circumferential direction of the hub plate 2 or in the direction along a tangent line. For example, a coil spring, a diaphragm spring, a rubber block or the like may be adopted as the elastic member 6. According to the exemplary embodiment of the present disclosure, the elastic member 6 comprises a coil spring 6a, and a plate 6b attached to a tip of the coil spring 6a.

In the hub plate 2 shown in FIG. 2, the elastic member 6 is arranged on each of the inner surfaces 5a-1 of the retainer 5. Instead, the elastic member 6 may also be arranged on the inner surface 5b-1 of the stopper 5b. For example, the elastic member 6 may be arranged on the inner surface 5a-1 of the predetermined stopper(s) 5a, and on the inner surface 5b-1 of another stopper(s) 5b. According to the exemplary embodiment of the present disclosure, the hub plate 2 is rotated clockwise, and in the hub plate 2 shown in FIG. 2, the elastic member 6 is arranged on each of the inner surfaces 5a-1 of the retainer 5 situated in the back side in a direction of a movement of the hub plate 2. Accordingly, all of the centrifugal weights 4 are pushed by the elastic member 6 in the rotational direction of the hub plate 2.

As described, the centrifugal weight 4 is held in each of the retainers 5. The centrifugal weight 4 comprises a shaft 4a held in the retainer 5, and a pair of masses 4b formed integrally with the shaft 4a. Specifically, the shaft 4a comprises a shaft portion 4a-2, and a bearing 4a-1 fitted onto the shaft portion 4a-2. An outer diameter of the bearing 4a-1 is smaller than a clearance between the stoppers 5a and 5b of the retainer 5. That is, the centrifugal weight 4 is held in the retainer 5 such that the bearing 4a-1 is situated between the elastic member 6 and the inner surface 5b-1 of the stopper 5b. In the retainer 5, therefore, the centrifugal weight 4 is allowed to move in the circumferential direction between the stoppers 5a and 5b within a range of expansion and contraction of the elastic member 6.

Each of the masses 4b is a disc-shaped member (or a roller member) formed integrally with an end portion of the shaft portion 4a-2 protruding from the retainer 5 in the axial direction, and an outer diameter of each of the masses 4b is larger than lengths of the stoppers 5a and 5b.

During rotation of the hub plate 2, the centrifugal weights 4 revolve around the rotational center of the hub plate 2. In this situation, each of the centrifugal weights 4 is individually displaced radially outwardly in the retainer 5 by the centrifugal force, and eventually comes into contact to an after-mentioned raceway surface 7 of the inertia body 3. Consequently, the hub plate 2 is connected to the inertia body 3 through the centrifugal weights 4, and the torsional vibration damper 1 is brought into a condition to damp torsional vibrations resulting from a pulsation of the torque rotating the hub plate 2. As illustrated in FIG. 1, the inertia body 3 is a ring-shaped member, and oscillates relatively to the hub plate 2 in response to the pulsation of the torque rotating the hub plate 2. Specifically, an inner diameter of the inertia body 3 is larger than an outer diameter of a ring section of the hub plate 2, but smaller than a diameter of the hub plate 2 between leading ends of the retainer 5 across the rotational center of the hub plate 2.

The raceway surface 7 as a curved surface is formed on an inner circumference of the inertia body 3 in radially outer side of each of the retainers 5 of the hub plate 2. Specifically, the raceway surface 7 is formed on both sides of the inertia body 3, and hence a total thickness of the pair of raceway surfaces 7 in the axial direction is substantially identical to a total thickness of the masses 4b of the centrifugal weight 4 in the axial direction. In other words, each of the raceway surfaces 7 is an arcuate surface curved or depressed radially outwardly being opposed to the mass 4b of the centrifugal weight 4 held in the retainer 5. On the other hand, in the centrifugal weight 4, the masses 4b are isolated away from each other in the axial direction so that each of the masses 4b comes into contact to each of the raceway surfaces 7 formed on both sides of the inertia body 3.

A curvature radius of the raceway surface 7 is shorter than a radius of the inertia body 3 between the rotational center of the inertia body 3 and the raceway surface 7 but longer than a radius of the mass 4b. Specifically, an intermediate portion of the raceway surface 7 in the circumferential direction that is farthest from the rotational center of the inertia body 3 (or the hub plate 2) is a neutral point. The mass 4b comes into contact to the neutral point of the raceway surface 7 as long as the torque rotating the hub plate 2 is smooth, and when the mass 4b is oscillated in any of the circumferential direction by the pulsation of the torque, the centrifugal weight 4 is pushed back radially inwardly by the raceway surface 7 toward the rotational center of the hub plate 2. In this situation, a tangent line at a contact point between the mass 4b and the raceway surface 7 extends perpendicular to a normal line of the raceway surface 7 connecting a center of curvature of the raceway surface 7 and the contact point between the mass 4b and the raceway surface 7. However, the above-mentioned tangent line slants with respect to a normal line of the inertia body 3 (or the hub plate 2) connecting the rotational center of the inertia body 3 (or the hub plate 2) and the contact point between the mass 4b and the raceway surface 7. That is, in a situation where the centrifugal weight 4 is centrifugally pushed onto the raceway surface 7, a torque (or a circumferential force) will act between the inertia body 3 and the centrifugal weight 4 or the hub plate 2 in a direction to move the centrifugal weight 4 to the neutral point. Thus, the above-mentioned torque acts in the direction to eliminate a relative displacement between the inertia body 3 and the hub plate 2, or to correct a relative position between the inertia body 3 and the hub plate 2. Consequently, torsional vibrations resulting from pulsation of the torque rotating the hub plate 2 will be damped.

As a result of eliminating the relative displacement between the inertia body 3 and the hub plate 2 by the centrifugal force of the centrifugal weight 4, the centrifugal weight 4 is displaced radially outwardly within the retainer 5 so that the mass 4b of the centrifugal weight 4 comes into contact to the neutral point of the raceway surface 7. In this situation, the inertia body 3 is oscillated relatively to the hub plate 2 repeatedly by the torque pulse, and hence the centrifugal weight 4 reciprocates repeatedly in the radial direction within the retainer 5. As described, the above-mentioned torque is transmitted between the hub plate 2 and the inertia body 3 through the centrifugal weights 4. Consequently, the each of the centrifugal weights 4 is subjected repeatedly to the circumferential force, and the shaft 4a thereof is repeatedly pushed onto the inner surface 5a-1 and the inner surface 5b-1 of the retainer 5.

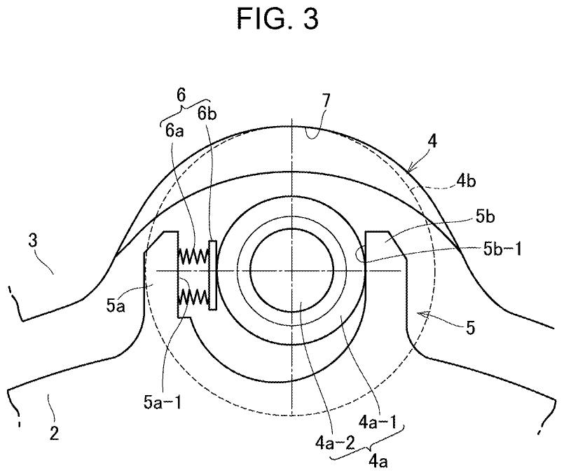

As described, a plurality of the retainers 5 (i.e., more than three retainers 5) are formed on the hub plate 2 at regular intervals in the circumferential direction, and same number of pairs of the raceway surfaces 7 (i.e., more than three pairs of the raceway surfaces 7) are formed on the inertia body 3 at regular intervals in the circumferential direction. As also described, during rotation of the hub plate 2, each of the centrifugal weights 4 is pushed onto each of the raceway surfaces 7 by the centrifugal force. In this situation, if the torque applied to the hub plate 2 is smooth, each of the centrifugal weights 4 is individually pushed onto the neutral point of the raceway surface 7 as illustrated in FIG. 3. Specifically, FIG. 3 shows an example in which the raceway surface 7 is formed accurately within a margin for machining error or perfectly accurately with no error. When the centrifugal weight 4 reciprocates in the radial direction within the retainer 5, the shaft 4a of the centrifugal weight 4 rolls on the inner surface 5b-1 of the stopper 5b. According to the example shown in FIG. 3, specifically, the shaft 4a of the centrifugal weight 4 is pushed onto the inner surface 5b-1 of the stopper 5b by the elastic member 6 in the situation where the mass 4b of the centrifugal weight 4 is situated at the neutral point of the raceway surface 7. That is, the circumferential force (or torque) is not acting between the raceway surface 7 (or the inertia body 3) and the centrifugal weight 4 in this situation.

As described, when the inertia body 3 is oscillated relatively to the hub plate 2 by the pulsation of the torque, the centrifugal weights 4 are reciprocated within the retainers 5 in the radial direction. In this situation, when the mass 4b of the centrifugal weight 4 is displaced from the neutral point of the raceway surface 7, the above-mentioned force (or torque) returning the mass 4b of the centrifugal weight 4 to the neutral point of the raceway surface 7 is established in accordance with the centrifugal force of the centrifugal weight 4, and such torque serves as a vibration damping force for damping vibrations resulting from the torque pulse. A direction of the torque thus acting between the hub plate 2 and the inertia body 3 is switched alternately in the circumferential direction by the oscillating motion of the inertia body 3 relative to the hub plate 2. Consequently, the centrifugal weight 4 reciprocates in the radial direction along the inner surface 5b-1 of the stopper 5b while being pushed onto the inner surface 5b-1 of the stopper 5b by the plate 6b of the elastic member 6. In this situation, specifically, a pushing force of the centrifugal weight 4 applied to the inner surface 5b-1 of the stopper 5b and a reaction force of the inner surface 5b-1 of the stopper 5b against the pushing force of the centrifugal weight 4 act as a vibration damping torque between the hub plate 2 and the inertia body 3. Likewise, a pushing force of the centrifugal weight 4 applied to the inner surface 5a-1 of the stopper 5a through the elastic member 6 and a reaction force of the inner surface 5a-1 of the stopper 5a against the pushing force of the centrifugal weight 4 also act as the vibration damping torque between the hub plate 2 and the inertia body 3.

When the elastic member 6 is compressed by the centrifugal weight 4, the shaft 4a of the centrifugal weight 4 is isolated away from the inner surface 5b-1 of the stopper 5b. Then, when the direction of action of the torque is reversed, the shaft 4a of the centrifugal weight 4 comes into contact to the inner surface 5b-1 of the stopper 5b. In this situation, since the centrifugal weight 4 is pushed toward the stopper 5b by the elastic member 6, an impactive force of the centrifugal weight 4 applied to the inner surface 5b-1 of the stopper 5b is not so strong. Therefore, the damage of the stopper 5b may be limited. In addition, since the plate 6b of the elastic member 6 always comes into contact to the centrifugal weight 4, the impactive force of the centrifugal weight 4 will be mitigated even if the centrifugal weight 4 isolated away from the inner surface 5b-1 of the stopper 5b will come into contact again to the inner surface 5b-1 of the stopper 5b. For this reason, the damage of the stopper 5b may be further limited.

In addition, since the centrifugal weight 4 moves away from the inner surface 5b-1 of the stopper 5b when subjected to the torque in the direction to compress the elastic member 6, a contact pressure between the centrifugal weight 4 and the inner surface 5b-1 of the stopper 5b is eliminated in this situation. In this situation, therefore, a sliding resistance between the centrifugal weight 4 and the inner surface 5b-1 of the stopper 5b is eliminated so that the centrifugal weight 4 is allowed to reciprocate smoothly in the retainer 5. For this reason, the vibration damping performance of the torsional vibration damper 1 is improved.

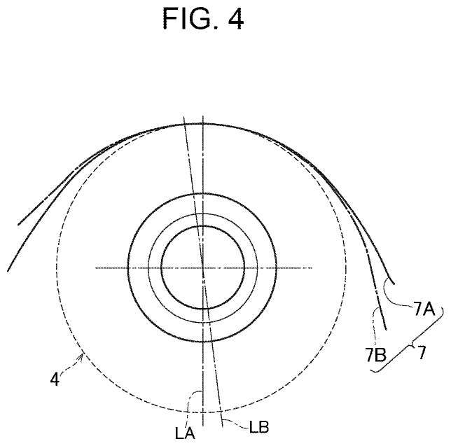

Turning to FIG. 4, there is shown an example in which the raceway surface 7 is formed with a machining error. In the example shown in FIG. 4, an actual profile 7B of the raceway surface 7 is slightly deviated from a designed profile 7A due to machining error. In this case, an actual neutral point of the raceway surface 7 is shifted in the rotational direction from the designed point. Specifically, as illustrated in FIG. 4, an actual center line LB passing through the actual neutral point of the raceway surface 7 and a center of the centrifugal weight 4 is inclined with respect to a designed center line LA passing through the designed neutral point of the raceway surface 7 and the center of the centrifugal weight 4.

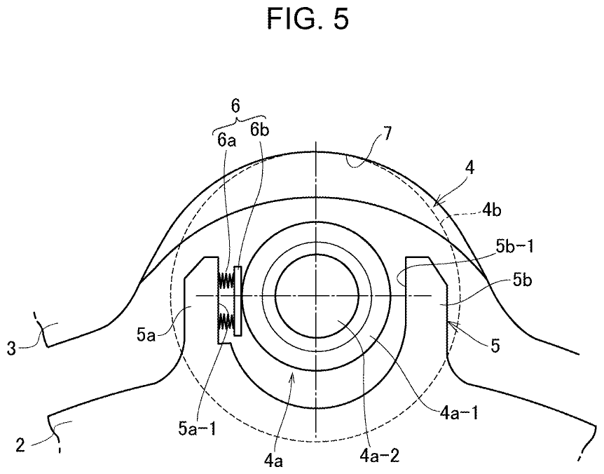

In this case, the centrifugal weight 4 will be moved toward the neutral point in the actual profile 7B of the raceway surface 7 by the centrifugal force, and hence the centrifugal weight 4 is subjected to the force acting in the leftward direction in FIG. 4. Consequently, the actual center line LB coincides with a normal line at the neutral point. That is, the actual center line LB coincides with the designed center line LA. As described, the elastic member 6 is interposed between the inner surface 5a-1 of the stopper 5a and the centrifugal weight 4. Therefore, as illustrated in FIG. 5, the centrifugal weight 4 is moved to the neutral point in the actual profile 7B of the raceway surface 7 by the above-explained force while compressing the elastic member 6.

The centrifugal weight 4 is guided by the retainer 5 in a direction along the designed center line LA or the actual center line LB. Therefore, given that the centrifugal weight 4 is contacted to the neutral point in the actual profile 7B of the raceway surface 7 formed with a machining error, the retainer 5 would be situated obliquely with respect to the designed center line LA. However, as a result of the above-explained movement of the centrifugal weight 4 in the direction to compress the elastic member 6, the actual center line LB coincides with the designed center line LA thereby correcting such inclination of the retainer 5 with respect to the designed center line LA. In the situation shown in FIG. 5, therefore, the centrifugal weight 4 is also allowed to reciprocate smoothly along the inner surfaces 5a-1 and 5b-1, even if the centrifugal weight 4 comes into contact to the inner surface 5b-1 and moves away from the inner surface 5b-1. In addition, since the elastic member 6 is interposed between the inner surface 5a-1 of the stopper 5a and the centrifugal weight 4, the impactive force of the centrifugal weight 4 applied to the inner surface 5b-1 of the stopper 5b and the sliding resistance between the centrifugal weight 4 and the inner surface 5b-1 of the stopper 5b may also be reduced, as the case in which the raceway surface 7 is formed accurately.

By thus arranging the elastic member 6 in any of the retainers 5, the vibration damping performance of the torsional vibration damper 1 will not be reduced by a machining error of the raceway surface 7 and misalignment of the retainer 5 due to the machining error of the raceway surface 7. In order to ensure the vibration damping performance of the torsional vibration damper 1, the elastic member 6 may be arranged in at least any one of the retainers 5. In the example shown in FIG. 2, the elastic member 6 is arranged in all of the retainers 5 in the same orientation so that the elastic forces of all of the elastic members 6 act in the same direction. In this case, the elastic forces of the elastic members 6 serve as the torque to rotate the inertia body 3 relatively to the hub plate 2. Therefore, given that the raceway surface 7 is formed accurately, and that the torque rotating the hub plate 2 is smooth and hence the inertia body 3 is not oscillated relatively to the hub plate 2, the shaft 4a of the centrifugal weight 4 comes into contact to the inner surface 5b-1 of the stopper 5b as illustrated in FIG. 3.

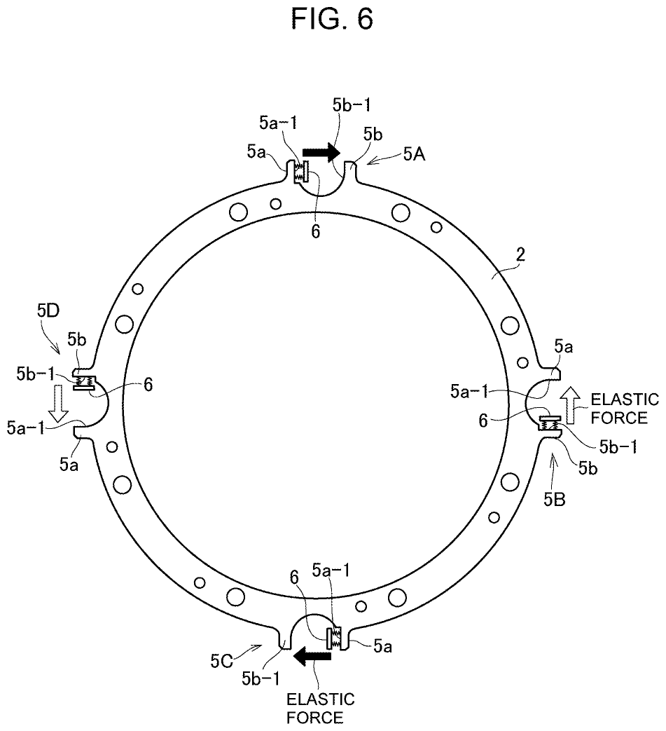

According to the present disclosure, the elastic members 6 may also be arranged in such a manner that the elastic force(es) of the elastic member(s) 6 will not serve as a torque to rotate the inertia body 3 relative to the hub plate 2. Turning to FIG. 6, there is shown a second example of the hub plate 2. In the hub plate 2 shown in FIG. 6, the elastic members 6 are arranged on the inner surfaces 5a-1 of the stoppers 5a in the retainers 5A and 5C opposed to each other in the radial direction, and arranged on the inner surfaces 5b-1 of the stoppers 5b in the retainers 5B and 5D opposed to each other in the radial direction. That is, the elastic members 6 are arranged such that the elastic forces established by the elastic members 6 arranged in a predetermined pair of the retainers 5A and 5C act in an opposite direction to a direction of action of the elastic forces established by the elastic members 6 arranged in another predetermined pair of the retainers 5B and 5D. In other words, in the adjoining retainers 5, the elastic members 6 are arranged in opposite directions to establish the elastic forces in opposite directions.

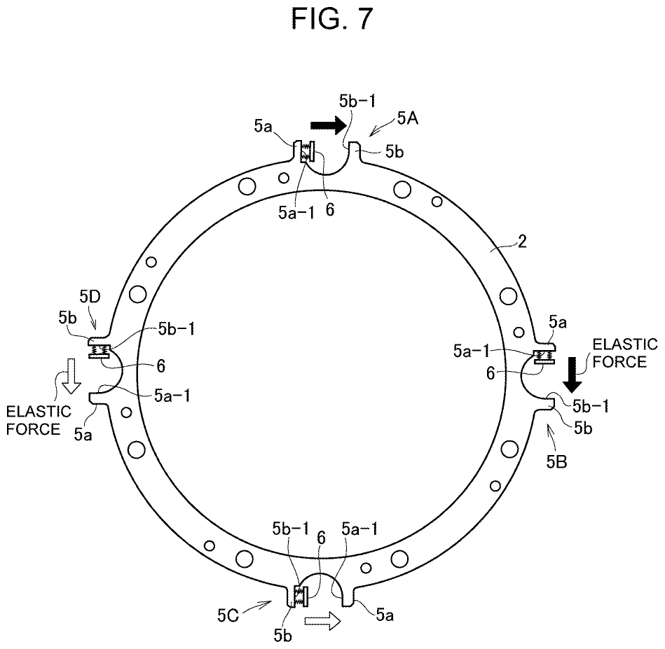

Turning to FIG. 7, there is shown a third example of the hub plate 2. In the hub plate 2 shown in FIG. 7, the elastic members 6 are arranged in opposite directions in the retainers 5A and 5C opposed to each other in the radial direction, and arranged in opposite directions in the retainers 5B and 5D opposed to each other in the radial direction. That is, the elastic members 6 are arranged on the inner surfaces 5a-1 of the stoppers 5a in the adjoining retainers 5A and 5B, and arranged on the inner surfaces 5b-1 of the stoppers 5b in the adjoining retainers 5C and 5D.

Since the elastic forces of all of the elastic members 6 are identical to one another, according to the second and third examples, the elastic forces of the elastic members 6 cancel one another out. Therefore, given that the hub plate 2 is rotated by a smooth torque without generating vibrations, the shaft 4a of the centrifugal weight 4 is situated at the intermediate site between the stoppers 5a and 5b of the retainer 5 without contacting to the inner surface 5a-1 or 5b-1 of the stopper 5a or 5b on which the elastic member 6 is not arranged. In this situation, therefore, the centrifugal weight 4 is allowed to reciprocate smoothly in the radial direction within the retainer 5 so that the vibration damping performance of the torsional vibration damper 1 can be ensured. In addition, since the centrifugal weight 4 is pushed by the elastic member 6 toward the inner surface 5a-1 or 5b-1 of the stopper 5a or 5b on which the elastic member 6 is not arranged, a clearance between the centrifugal weight 4 and the inner surface 5a-1 or 5b-1 is rather narrow. For this reason, an impactive force of the centrifugal weight 4 applied to the inner surface 5a-1 or 5b-1 is not so strong, and hence the damage of the stopper 5a or 5b may be limited.

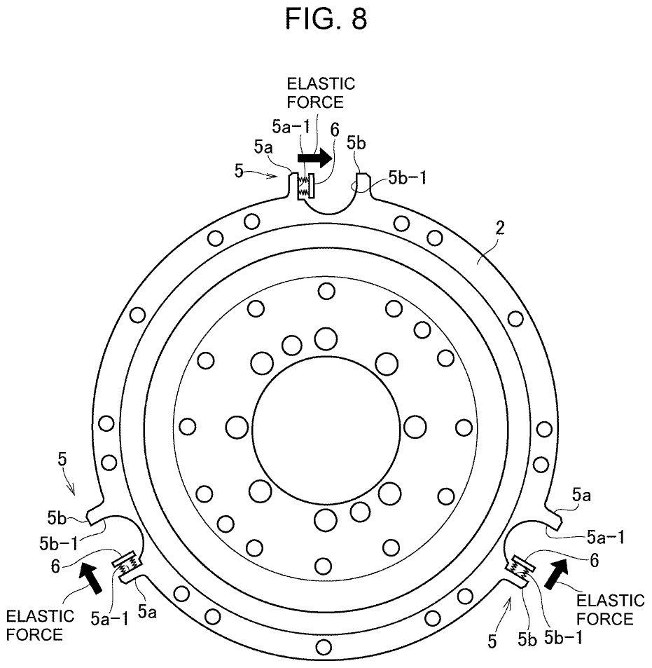

Turning to FIG. 8, there is shown a fourth example of the hub plate 2 in which an odd number of the retainers 5 are formed on the hub plate 2. According to the fourth example, specifically, three retainers 5 are formed on the hub plate 2. Accordingly, three pairs of the raceway surfaces 7 are formed on the inertia body 3 so that the hub plate 2 is connected to the inertia body through three centrifugal weights 4 held in the retainers 5. That is, three elastic members 6 are arranged in the retainers 5. According to the fourth example, therefore, the torques derived from the elastic forces of the elastic members 6 may not be balanced out one another. However, according to the fourth example, the number of the elastic members 6 may be reduced to one at the minimum. That is, the torque acting between the hub plate 2 and the inertia body 3 may be reduced to the minimum so that the inertia body 3 is allowed to oscillate smoothly.

Although the above exemplary embodiments of the present disclosure have been described, it will be understood by those skilled in the art that the present disclosure should not be limited to the described exemplary embodiments, and various changes and modifications can be made within the scope of the present disclosure. For example, shapes of the hub plate 2, the centrifugal weight 4, the inertia body 3, and the retainers 5 may be altered as long as the foregoing actions of the torsional vibration damper 1 can be ensured. In addition, the numbers of the retainers 5, the pair of raceway surfaces 7, the centrifugal weights 4 may also be altered as long as the foregoing actions of the torsional vibration damper 1 can be ensured.

What is claimed is:

1. A torsional vibration damper comprising:
a rotary member that is rotated by a torque applied thereto;
a retainer that is formed on the rotary member to extend radially outwardly;
a rolling member that is held in the retainer while being allowed to reciprocate in a radial direction of the rotary member; and
an inertia body that is arranged coaxially with the rotary member while being allowed to oscillate relatively to the rotary member,
wherein the rolling member comprises
a shaft that is inserted into the retainer to be guided in the radial direction by the retainer, and
a pair of masses formed on end portions of the shaft to be rotated integrally with the shaft,
the inertia body comprises a raceway surface to which the mass of the rolling member is centrifugally contacted,
the retainer comprises a pair of inner surfaces opposed to each other in a circumferential direction across the shaft of the rolling member, and
the torsional vibration damper further comprises an elastic member that is arranged on any one of the inner surfaces of the retainer to push the shaft of the rolling member toward the other one of the inner surfaces of the retainer.

2. The torsional vibration damper as claimed in claim 1,
wherein the shaft comprises a shaft portion formed integrally with the pair of masses and a bearing fitted onto the shaft portion, and
the elastic member pushes an outer circumferential surface of the shaft portion.

3. The torsional vibration damper as claimed in claim 1,
wherein a plurality of the retainers is formed on the rotary member at regular intervals in the circumferential direction, and
the elastic members are arranged in the retainers in such a manner as to push the shafts of the rolling members in the same direction.

4. The torsional vibration damper as claimed in claim 1,
wherein a plurality of the retainers is formed on the rotary member at regular intervals in the circumferential direction, and
the elastic member arranged in a predetermined retainer of the plurality of the retainers pushes the shaft of the rolling member in an opposite direction to a direction to push the shaft of the rolling member by the elastic member arranged in another predetermined retainer of the plurality of the retainers.

5. The torsional vibration damper as claimed in claim 1,
wherein an even number of the retainers are formed on the rotary member at regular intervals in the circumferential direction,
the elastic members arranged in a predetermined pair of the retainers opposed to each other in the radial direction push the shafts of the rolling members in the same direction, and
the elastic members arranged in another predetermined pair of the retainers opposed to each other in the radial direction push the shafts of the rolling members in the same direction, which is opposite to the direction to push the shafts of the rolling members by the elastic members arranged in the predetermined pair of the retainers.

6. The torsional vibration damper as claimed in claim 1,
wherein an even number of the retainers are formed on the rotary member at regular intervals in the circumferential direction, and
the elastic members are arranged in a predetermined pair of the retainers opposed to each other in the radial direction push the shafts of the rolling members in opposite directions.

7. The torsional vibration damper as claimed in claim 1,
wherein the raceway surface includes a curved surface depressed radially outwardly that is formed on the inertia body in radially outer side of the mass held in the retainer, and
a curvature radius of the curved surface is shorter than a radius of the inertia body between a rotational center of the inertia body and the curved surface.
